(19) United States
(12) Patent Application Publication
(10) Pub. No.: US 2026/0364521 A1
(43) Pub. Date: Nov. 19, 2026

(54) PLANT AND PROCESS FOR THE CAPTURE AND RECOVERY OF CO2 FROM PROCESS FUMES

(71) Applicant: Danieli & Officine Meccaniche S.P.A, Buttrio (IT)

(72) Inventors: Selena TIBURZIO, Buttrio (IT); Daniela DALLE NOGARE, Buttrio (IT); Marco LAPASIN, Buttrio (IT)

(73) Assignee: Danieli & C. Officine Meccaniche S.P.A, Buttrio (IT)

(21) Appl. No.: 19/132,071

(22) PCT Filed: Nov. 22, 2023
(86) PCT No.: PCT/IB2023/061770

§ 371 Date: May 22, 2025

(30) Foreign Application Priority Data
Nov. 23, 2022 (IT) 102022000024102

(51) Int. Cl. B01D 53/047; B01D 53/14; B01D 53/22; B01D 53/62

(52) U.S. Cl. CPC B01D 53/047; B01D 53/1475; B01D 53/1493; B01D 53/229; B01D 53/62; B01D 2251/304; B01D 2251/306; B01D 2251/604; B01D 2251/606; B01D 2252/204; B01D 2257/504; B01D 2258/025

(57) ABSTRACT

The invention relates to a plant (10) and a process for the capture and recovery of CO₂ from the fumes of a reheating furnace. The carbon dioxide is captured and divided in a CO2 capture and separation unit (C) into two CO₂ flows (F1, F2) by means of membrane separation, adsorption separation, as with PSA technology, or chemical absorption and gas regeneration. One of the two flows (F1) feeds a washing device (18) wherein the CO₂ passes through a solution of an alkali metal hydroxide MOH, in particular NaOH or KOH, to form M₂CO₃ which in a downstream reactor (24) is reacted with the second CO₂ flow (F2) to form alkali metal bicarbonate (MHCO₃). The heat recovered from the fumes can be utilized in various parts/stages of the plant/process of the invention.

### TECHNICAL FIELD

The present invention relates to a process and a production plant for the capture, separation and use of carbon dioxide flows to be used for the production of bicarbonates, such as sodium bicarbonate, through a CCU (Carbon Capture and Usage) approach. In particular, the CO₂ contained in the process fumes of furnaces, in particular of a reheating furnace, will be captured and used.

### BACKGROUND OF THE INVENTION

In the melting and reheating phases, steel plants are quite impactful in terms of CO₂ emissions, since they include the combustion of hydrocarbons and carbonaceous materials for the different process phases.

In particular, melting furnaces are particularly productive, which generate discrete quantities of CO₂ in the fumes which, however, contain a lot of dust, and methane reheating furnaces, which instead generate flows of combustion fumes that are poorer in terms of dustiness.

This second category of fumes contains about 10% carbon dioxide and the annual amount of CO₂ of one of these furnaces can reach 200,000 tonnes.

Furthermore, these fumes are transported at high temperatures, whereby in order to be treated they must first be cooled, and then introduced in the atmosphere.

These reheating furnaces therefore have a considerable impact due to climate-altering emissions and are burdensome for a plant in terms of payment of emissions taxes (known as the carbon tax), an impact that is expected to increase over the coming years. Other CO₂ producing furnaces in the metal or steel sector are, for example, furnaces for the heat treatment of metal products.

### DISCLOSURE OF THE INVENTION

The object of the invention is to overcome the aforesaid drawbacks and to propose a plant and related process for capturing the CO₂ produced inside furnaces, such as reheating furnaces, heat treatment furnaces, melting furnaces, etc. A further object of the invention is to find a solution for recovering and reusing the CO₂ to reduce the impact of steel production on the climate, but also of the products that will be replaced by what is produced with the new technological process.

Further objects and advantages of the invention will become apparent from the following description.

In a first aspect of the invention, the object is achieved by a plant for capturing and recovering CO₂ from process fumes comprising:
(a) a furnace producing, during use, heat and fumes containing CO₂;
(b) a CO₂ capture and separation unit downstream of said reheating furnace, with a first outlet and relative first duct and with a second outlet and relative second duct, wherein each outlet and relative duct is fed during use by a gas flow containing a portion of the captured and separated CO₂, said gas flow having a different CO₂ concentration with respect to that fed to the CO₂ capture and separation unit;
(c) a first gas washing device, preferably an absorption column, adapted to wash the CO₂ with aqueous MOH, wherein M is an alkali metal, preferably sodium (Na) or potassium (K), and connected to said first duct for feeding with CO₂;
(d) a reactor adapted to execute a reaction between an alkali metal carbonate, preferably of Na or K, and CO₂, preferably in aqueous solution, connected to said second duct and to said first gas washing device for feeding respectively with CO₂ and the alkali metal carbonate, preferably of Na or K, and provided with a discharge for the extraction of the alkali metal bicarbonate produced during the use of the plant by a reaction between CO₂ and the alkali metal carbonate.

The plant helps to recover CO₂ in the form of alkali metal bicarbonate, a product that has a variety of uses, including food applications, in particular NaHCO₃ (e.g., leavening agents), medical (e.g., haemodialysis) and hygienic (cleaning with bicarbonate). The proposed alkali metal bicarbonate production can be conducted on an industrial scale. The bicarbonate of the alkali metal M is produced here by the reaction process between the carbonate of the alkali metal M with the carbon dioxide in an aqueous solution according to the following equation (I):

M₂CO₃+H₂O+CO₂→2 MHCO₃, (I)

obtaining the necessary alkali metal carbonate according to the following equation (II):

2 MOH+CO₂→M₂CO₃+H₂O, (II)

wherein the alkali metal hydroxide in aqueous solution, suitably contacted with the carbon dioxide, reacts to form water and alkali metal carbonate. Both reactions capture and recover carbon dioxide in the form of salt.

The preferred alkali metals are sodium and potassium, with a particular preference for sodium. The furnace can be of various nature, for example a melting furnace, a reheating furnace, a heat treatment furnace, etc. Particularly preferred types of furnaces are those that produce fumes with a relatively low dust content (indicatively, for example, dust contents in the order of magnitude of 50 mg/Nmc), such as reheating furnaces or those for heat treatments.

The reheating furnace is commonly used in metal and steel processes. It is usually powered by natural gas and produces carbon dioxide during combustion at high temperatures, which thus also allows the heat of the fumes to be used.

The reheating furnace allows to have fumes with little dust, and to limit the pre-treatments necessary to be able to process its fumes together with the alkali metal hydroxide and derivatives thereof to sustainably produce alkali metal bicarbonate. In case of need, i.e., for fumes containing large amounts of dust, it is preferable to insert a dust removal system between the furnace and the CO₂ capture unit, of which the market has a wide range well known to the person skilled in the art.

In light of the characteristics of the fumes generated inside the furnaces and of the chemical reactions necessary to produce alkali metal bicarbonate, the present invention describes a plant and a process for producing alkali metal bicarbonate which is capable of using the carbon dioxide produced by the reheating processes (or at least part thereof) in addition to using the heat of the fumes, in order to produce alkali metal bicarbonate.

This makes it possible to reduce the environmental impact of these furnaces, to expand the production fleet of a steel plant, which in addition to steel products can also market chemical products, but can also compensate the emissions of other areas of the plant with the non-emissions of the part of the plant subject-matter of the invention.

The CO₂ capture unit allows to capture the gas and separate it from the fumes (i.e., from any other contained gases and powders) and then to concentrate it to recover it and reuse it in the form of alkali metal bicarbonate or derivatives thereof.

The gas flows or fumes feeding the capture unit have a certain CO₂ concentration (for example expressed in vol %) which during the passage through the capture unit is varied creating two distinct gas flows, the concentration of which can vary between 40% and 95% by volume. A concentration difference expressed in a given concentration amount (e.g., m %, vol %, mol %, etc.) consequently means a difference in any other concentration amount, the concentration amounts being convertible therebetween.

The gas flow is understood as a flow of substances which at room temperature are gaseous, but which in the present case can also be liquefied and not necessarily in the gaseous state, in particular in the case of fluids which have passed a compression system.

As already mentioned above, the thermal energy of the fumes produced by the reheating furnace can also be recovered and used in other parts of the plant or the relative process.

In this regard, in a preferred embodiment, the CO₂ capture and recovery plant according to the invention comprises a first heat exchanger downstream of said furnace in order to recover the heat from the fumes inside the plant. The recovered heat could be useful, as will be illustrated later, for example, to heat a CO₂ regeneration device or the solution treated therein, or to evaporate the water in a concentrator which is part of the extraction system of the alkali metal bicarbonate from the reactor and is adapted to treat the remaining solution (after crystallizing the salt) in order to recover it.

In order to be able to isolate the alkali metal bicarbonate, the CO₂ capture and recovery plant according to the invention advantageously further comprises a crystallizer which is connected to the reactor discharge; a filter or a centrifuge for separating the alkali metal bicarbonate produced during use in the reactor; and a concentrator downstream of the filter or centrifuge which is connected to the reactor to feed it with the concentrate produced during the use of the plant. Any vapours generated inside the concentrator can be used to feed, after condensation, a tank-mixer which serves as a source of alkali metal hydroxide for the first gas washing device. Preferably, the reactor has a gas vent connected to the first duct in order to recirculate the CO₂ not transformed into alkali metal bicarbonate or formed by the possible decomposition of carbonates and bicarbonates and dispose of any pressure peaks.

The reactor is understood as a reaction unit, i.e., as a container, device, apparatus, plant wherein chemical reactions are made to occur. A particularly preferred reactor is a three-phase reactor, since there are three-phase reactions between CO₂ (gas), water (liquid) and sodium carbonate (at least partially solid and not in solution).

In a first embodiment thereof, the capture unit uses chemical reactions or the phenomenon of absorption to separate carbon dioxide from other components of the fumes and then performs a first purification of CO₂; the CO₂ not captured by means of chemical reaction or absorption, for example by means of potassium carbonate or amines, is captured during the formation of the carbonate (M₂CO₃) which combines the CO₂ with MOH, so that both CO₂ fractions reach the reactor for the production of alkali metal bicarbonate, the first by means of the reaction with potassium carbonate or amines or other separation systems, the second by means of the reaction with MOH. The amines form carbamates with the CO₂ (equation III); and the potassium carbonate forms potassium bicarbonate in reaction with the CO₂ (equation IV). During the regeneration of the CO₂, the reaction occurs in the opposite direction and releases the gas, recovering the respective capturing agent:

2 R₁R₂NH+CO₂↔R₁R₂NCOO⁻+R₁R₂NH₂⁺ (III)

K₂CO₃+H₂O+CO₂↔2KHCO₃ (IV)

In the case of potassium bicarbonate production from carbon dioxide capture and recovery, an amine system capture is preferred.

Absorption with aqueous amine solutions is one of the most widely used processes for the removal of CO₂ from gaseous mixtures. The amine solutions react with CO₂ with two different mechanisms: the primary and secondary amines give rise to the formation of carbamates (equation III) with a mechanism which first sees the formation of a zwitterion and then its deprotonation by a second amine molecule, and the carbamate ion can, in turn, undergo partial hydrolysis with the formation of bicarbonate, therefore, next to the above reaction we can consider the overall reaction V:

R₁R₂NH+CO₂+H₂O↔R₁R₂NH₂⁺+HCO₃⁻. (V)

Tertiary amines, which do not have a free proton, do not give rise to the formation of carbamates but give, in any case, a basic reaction and thus form bicarbonate ions (equation VI):

R₁R₂R₃N+CO₂+H₂O↔R₁R₂R₃NH⁺+HCO₃⁻ (VI)

In order to reuse the amine solution used for absorption it is necessary to include a regeneration step which can be carried out by stripping with steam, at high temperature (for example, around 120-130 °C), which makes the process energy expensive, but can be managed with heat recovered from the same furnace, i.e., from other available heat sources. Solutions of monoethanolamine, diethanolamine and dimethylethanolamine, provided with a component for activation, are normally used.

In order to perform the chemical capture or absorption of CO₂, in a first embodiment thereof, the CO₂ capture and separation unit comprises a second gas washing device, preferably an absorption column, adapted to chemically bind or absorb CO₂ with an aqueous solution, preferably containing amines or potassium carbonate; and downstream of the second gas washing device a regeneration device adapted to release the CO₂ absorbed or bound in the gas washing device; wherein the second gas washing device comprises the first outlet and is connected by means of the first duct to the first gas washing device; and wherein the regeneration device comprises the second outlet and is connected by means of the second duct to the reactor.

The person skilled in the art knows various types of absorption columns, among which he/she selects with his/her general knowledge the one most suitable for his/her purposes. Chemical absorption can also be achieved with other chemical systems known to the person skilled in the art. Captures of the physical type can also be assumed, such as various forms of adsorption known in the field.

Advantageously, a heat exchange can be included within the capture and separation unit to heat/cool flows of substances. An embodiment of the invention envisages that the second gas washing device and the regeneration device are connected through a second heat exchanger to heat the flow of the solution with the captured CO₂ exiting the second gas washing device and destined for the regeneration device and correspondingly cool the regenerated solution exiting the regeneration device and heated by a heat source contained in the plant to feed the second gas washing device. Advantageously, the plant according to the invention comprises a compressor for compressing the CO₂ downstream of the regeneration device. This system makes it possible to cross-prepare flows of substances within a heat exchanger at the respective CO₂ capture and its treatment steps.

In a second embodiment thereof, the CO₂ capture and separation unit comprises at least one membrane separator, preferably a polymeric membrane, adapted to separate CO₂ from a gas flow, producing a first gas flow enriched with CO₂ and a second gas flow with reduced CO₂ content wherein the at least one membrane separator comprises the first outlet and the second outlet and feeds the first gas washing device with the gas flow with reduced CO₂ content through the first duct connected to the first outlet and feeds the reactor with the gas flow enriched with CO₂ through the second duct connected to the second outlet.

In this second embodiment of the capture unit, the ability of membranes, in particular polymeric membranes, to separate gas from gas flows is thus exploited. The separation effect is based on the differential diffusion mechanism in a membrane. In this case, the fumes produced by the furnace pass through a membrane separation unit, wherein the separation occurs in two flows at different gas concentrations. The gases which permeate through the membrane are enriched in the permeate, while they are depleted in the retentate. The separation occurs thanks to the different diffusion rate of the individual components in the membrane material. The driving force of the mass transport across the membrane is the partial pressure difference of the components permeating between the feed and permeation side. In terms of process technology, this difference is usually created with a lower pressure on the permeate side.

Often the separation efficiency of such membranes is so good that single-stage plants are sufficient, but multi-stage plants are also conceivable. In this case, a variant of the embodiment of the membrane separation envisages that at least one further membrane separator is inserted between said at least one membrane separator and the first gas washing device, the further membrane separator being fed by the low CO₂ content fraction exiting said first membrane separator and which feeds the second duct with the CO₂ enriched fraction and the first gas washing device with the reduced CO₂ content fraction. Further membrane separators can be inserted. All these separators can be connected in series, wherein the retentate exiting from one separator feeds the next separator and wherein each permeate of each separator can be guided in counter-current through the separators.

A (cross-flow) tangent feed is usually used. In the tangent flow, the feed flows tangentially to the membrane and is forced to cross the membrane by the pressure gradient acting on the two faces of the membrane itself. There is a formation of permeate flow orthogonal to the membrane and of retentate tangential thereto. This type of flow is used, for example, for treating fluids with high suspended solids content.

Various membrane variants exist. Spiral wound membranes comprise a series of pairs of flat membranes glued together on three sides and with the fourth connected to a central permeate collection channel. The membranes are then wound around the channel. The two membrane sheets are separated by a spacer net for permeate drainage. Hollow fibre membranes comprise a plurality of small tubes of gas-selective material inserted in a tube, then what are known as flat module or tubular module membranes are known. The person skilled in the art selects the membrane most suitable for his/her purposes according to his/her needs, evaluating for example parameters such as flow rate or flow velocity, selectivity, fouling and membrane cleaning, etc. To improve the separation effect, membrane separation can use a sweep gas, which is a gas present in the permeate side of a membrane separator to lower the partial pressure of the permeating species and increase the driving force. This gas is different from the gas being separated. The driving force can be increased by operating on the partial pressure, either by increasing the feed pressure or by reducing the pressure of the permeate of the specific gas. In particular, the partial pressure of a permeating species can be reduced in two modes: by reducing the total pressure on the permeate side, for example by applying a vacuum, and/or by using a sweep gas on the permeate side.

This causes membrane separation to be favoured when a pressure difference can be efficiently created and when a limited separation efficiency is required. This is the case here, where the separation of the fumes into two CO₂ flows is necessary to use them in the washing with MOH and in the reaction with alkali metal carbonate.

Polymeric membranes have a high permeance to CO₂ and a good selectivity with respect to other gases depending on the polymer and the gases to be separated. Multi-stage solutions are needed to achieve high separations and purities. Membrane separation is competitive especially for the treatment of pressurised gas (>5 bar). With the choice of polymer, from a wide range of polymers known to the person skilled in the art, it is possible to control the degree of separation.

A third embodiment of the invention envisages a physical capture, i.e., through adsorption, of CO₂, as already mentioned above. Separation with pressure swing adsorption (PSA) substances is particularly suitable.

PSA utilizes the different adsorption behaviour of gas molecules: under pressure, the adsorbent binds CO₂ better than other components of the gas, which can penetrate in the adsorbent material, such as hyper-crosslinked functionalised polymers, as described for example by Alex M. James et al. in A Pressure Swing Approach to Selective CO₂ Sequestration Using Functionalized Hypercrosslined Polymers (Materials 2021, 14, 1605) or with zeolites, carbon molecular settings or the like. If the adsorbent material is finally saturated with the main adsorbed CO₂, the process can be reversed, relieving the pressure and regenerating the adsorbent or also by washing the adsorbent material with a flow of a portion of the CO₂ first separated in the opposite flow direction. The CO₂ which has passed the adsorbent can be divided into two distinct flows and leave the capture unit through two relative distinct outlets and ducts to feed the first gas washing device and the reactor.

Capture units which combine different types of CO₂ capture are also conceivable, selected from membrane separators, adsorption separators, such as PSA, and chemical absorption systems. A second aspect of the invention relates to a process for the capture and recovery of CO₂ from process fumes comprising the following steps:
(i) producing heat and fumes containing CO₂ with a furnace;
(ii) capturing and separating said CO₂ in a capture unit;
(iii) dividing the captured and separated CO₂ into a first CO₂ flow and a second CO₂ flow;
(iv) washing said first flow with aqueous MOH with the production of alkali metal carbonate M₂CO₃, wherein M is preferably Na or K;
(v) reaction between said alkali metal carbonate and said second CO₂ flow (F2) with the formation of alkali metal bicarbonate MHCO₃; and
(vi) separating said alkali metal bicarbonate.

Preferably, the process at least partially uses the heat from the furnace, in particular from the heat contained in the fumes. Possible uses of heat have been described above with reference to the plant according to the invention.

The features described for one aspect of the invention may be transferred mutatis mutandis to the other aspects of the invention. Transfer is implicit, as certain elements of the plant (e.g., the membrane separator) correspond to respective steps of the process (e.g., membrane separation) and vice versa.

In an advantageous embodiment of the process for the capture and recovery of CO₂ according to the invention, the capture and separation of CO₂ in step (ii) occurs
(ii-a) by washing the CO₂ with a solution, preferably comprising amines or potassium carbonate, which absorbs or chemically binds the CO₂; and
(ii-b) the subsequent release or regeneration of the CO₂ absorbed or bound in step (ii-a), wherein unabsorbed or bound portions of CO₂ in step (ii-a) form the first CO₂ flow and the CO₂ released or regenerated in step (ii-b) forms the second CO₂ flow. This capture and separation of CO₂ perfectly reflects the relative part of the plant illustrated above and vice versa.

In a preferred variant thereof, the process according to the invention, using the principle of chemical absorption, envisages that the solution freed from CO₂ is heated and then reused in step (ii-a) by heating the solution containing the CO₂ absorbed or bound between step (ii-a) and step (ii-b) with this heated solution, before its reuse in step (ii-a), in a heat exchanger. These additional phases allow to use two flows of substances at different temperatures in a “crossed” form in a heat exchange to heat/cool them according to the needs of the process, taking advantage of heat sources inherent in the process and not procured from the outside with an energy burden.

In an alternative embodiment of the capture and separation of CO₂, the process according to the invention envisages the advantageous use of membrane gas separation technology to be able to create two separate CO₂ flows: in this case, advantageously, the capture and separation of CO₂ in step (ii) occurs with a membrane separation which generates an enriched flow of CO₂ which forms the second flow of CO₂ and in a flow with a reduced content of CO₂ which forms the first flow of CO_{2.}

In a further alternative embodiment of the capture and separation of CO₂, the process according to the invention envisages the use of adsorption separation technology, in particular with PSA technology: in this case, advantageously, the capture and separation of CO₂ in step (ii) occurs with an adsorption separation and the generation of two flows of CO₂.

The plant and the process according to the invention are applicable for the production of bicarbonates of different alkali metals, in particular of sodium and potassium.

### BRIEF DESCRIPTION OF THE DRAWINGS

FIG. 1 depicts a basic diagram of the principle of the capture and recovery of CO₂ deriving from a reheating furnace of a metallurgical plant.

FIG. 2 details the diagram of FIG. 1 in the part related to the formation of bicarbonate from carbonate.

FIG. 3 details the diagram of FIG. 2 relating to the capture unit by presenting a first capture variant, in the present case a capture by chemical absorption.

FIG. 4 details the diagram of FIG. 2 relating to the capture unit by presenting a second capture variant, in the present case a capture by means of a single-stage membrane separation.

FIG. 5 details the diagram of FIG. 2 relating to the capture unit by presenting a third capture variant, in the present case a capture by means of a two-stage membrane separation.

FIG. 6 depicts a gas separation membrane in section.

FIG. 7 depicts in a perspective view a hollow fibre separation membrane.

FIG. 8 depicts in a section a spiral separation membrane.

FIG. 9 depicts a configuration of the permeation membrane (on the left) and the trend of the partial pressure of the gas to be separated with respect to the surface traversed.

FIG. 10 depicts a configuration of the permeation membrane in combination with a sweep gas and the partial pressure trend of the gas to be separated with respect to the surface traversed.

### DESCRIPTION OF PREFERRED EMBODIMENT EXAMPLES

In the following, the executive examples are oriented to the production of sodium bicarbonate, but by replacing sodium, where appropriate, with another alkali metal such as potassium or lithium, they are transferable to the production of other alkali metal bicarbonates, such as potassium bicarbonate or lithium bicarbonate.

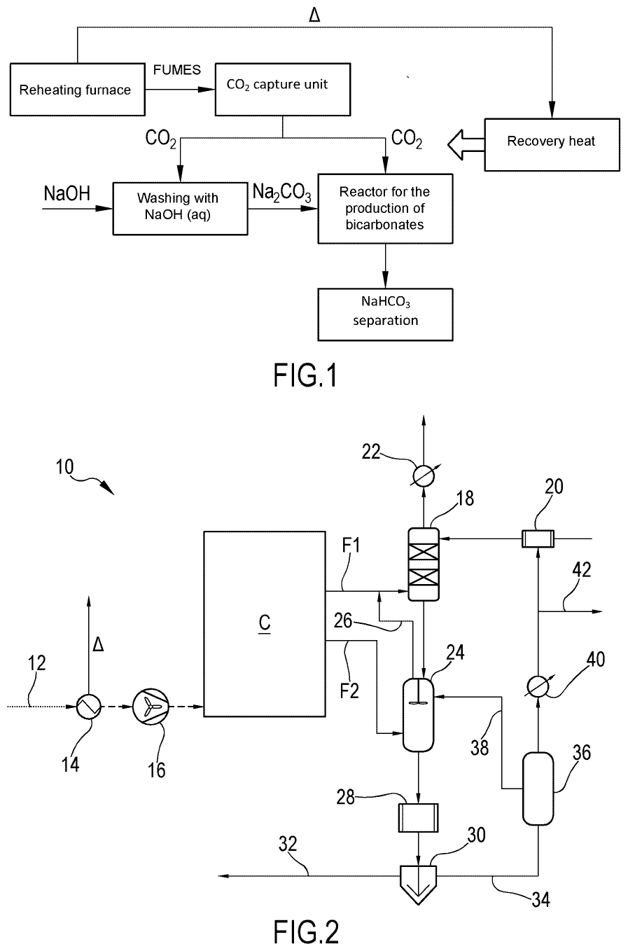

FIG. 1 depicts the basic diagram underlying the invention. A reheating furnace produces combustion fumes containing CO₂, which is captured by a capture unit. The captured carbon dioxide is then divided into two flows. The first is washed with a solution of NaOH to produce sodium carbonate (Na₂CO₃). The second reacts in a reactor with the carbonate produced by the first flow to form sodium bicarbonate (NaHCO₃) which is subsequently separated. The heat recovered from the reheating furnace can be used in the bicarbonate production process.

For the CO₂ capture step, the invention includes various embodiments, while the captured CO₂ recovery and use part (at least the majority thereof) is the same or similar for all the variants.

FIG. 2 therefore depicts in detail the part common to the various plants according to the invention and indicates with box C the part of the plant which concerns the initial capture and separation of the gas. 10 is instead used to indicate the CO₂ capture and recovery plant of CO₂ emitted by a reheating furnace (not shown) and entering (arrow 12) the plant 10. The hot, i.e., high-temperature, gases from the reheating furnace (RHF) with a concentration of about 10% carbon dioxide are cooled in a heat exchanger 14 and pumped through a compression system 16 into the CO₂ capture system C. The heat generated by the reheating furnace (A) is preferably used, at least partially, in the plant 10, as will be illustrated below. However, it can be used for other purposes. After capture, the gas is divided into two flows F1 and F2. The first flow F1 is guided into an absorption column 18, where it meets a counter-current flow of caustic soda injected from a tank 20. The tank 20 receives the NaOH in concentrated solution and is diluted in the mixer 20 before being introduced into the plant 10. The concentration of sodium hydroxide (NaOH) in solution corresponds for example to 10-25 m %. In the absorption column, with respect to the capture unit where a sequestration of about 50% of the CO₂ can occur, a further sequestration of the CO₂ occurs, for example for a portion of about 45%, which already corresponds to the first recovery step thereof. The gases thus purified from about 95% of the CO₂ then pass a condenser 22, or other similar device, and are disposed of by chimneys according to known procedures. Sodium carbonate (Na₂CO₃) exits the absorption column 18 in aqueous solution, produced by the reaction between NaOH and CO₂, which is sent to a reactor 24. The reactor 24 is simultaneously fed by the above second carbon dioxide flow F2. A recovery of CO₂ occurs in reactor 24 in the form of sodium bicarbonate (NaHCO₃) produced by the reaction between Na₂CO₃ and CO₂. A vent 26 placed on the reactor 24 optionally feeds the line of the first flow F1 with “unconsumed” carbon dioxide and allows to dispose of any pressure peaks. From the reactor 24, the bicarbonate in aqueous solution reaches a crystallizer 28 for salt precipitation. Downstream of the crystallizer 28 is a separation system 30, such as a filter or a centrifuge, which separates the solid salt (NaHCO₃) to be used for different uses (arrow 32), while the separated water (arrow 34) with bicarbonate residues contained therein is sent to a concentrator 36 which in turn re-sends the portion of water with bicarbonate residues (arrow 38), to the reactor 24 after having heated it so as to bring the excess water to vaporize by using variously recovered heat (for example from the reheating furnace itself). This vapour then passes through a condenser 40 which cools the vapour, by condensing it into water, so that it can be extracted (arrow 42) for other uses, or to be reused in the tank 20 to dissolve solid NaOH or dilute the caustic soda already in any aqueous solution.

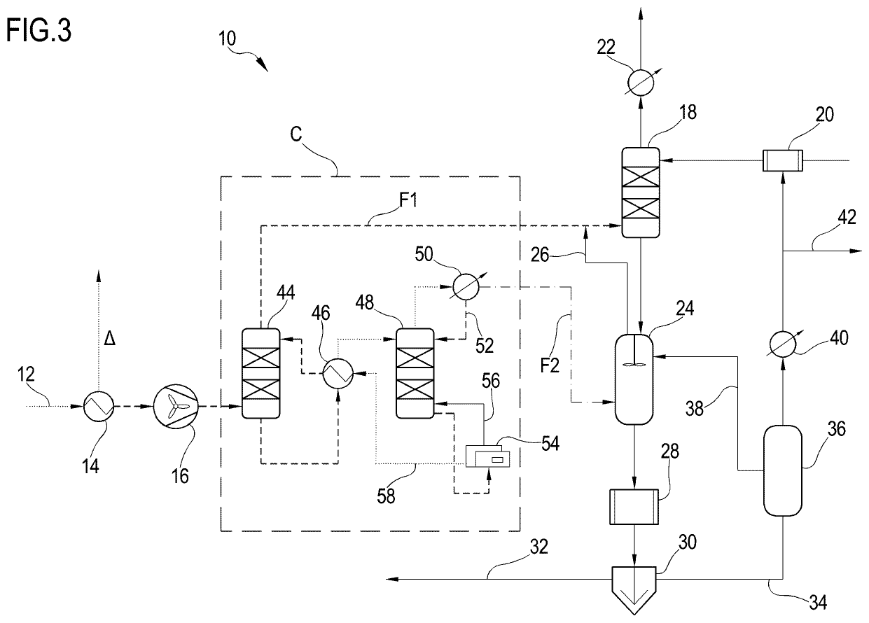

FIG. 3 illustrates an embodiment of the capture unit C of the previous figure. The part of the plant with the further capture of CO₂ for the purposes of its recovery as carbonate/bicarbonate is the same as FIG. 2 and is not illustrated again. The capture unit C works according to the chemical absorption principle. The fumes cooled by the exchanger 14 enter, after having passed the compression system 16, in a first stage in an absorption column 44. The cold fumes are introduced from the bottom of the column 44 and rise upwards. At the same time, they are crossed in counter-current by a flow of an absorbent liquid (such as potassium carbonate or amines in aqueous solution) which binds the CO₂ contained in the fumes, forming potassium bicarbonate or carbamates and thus subtracting about 50% or more of the carbon dioxide. The carbon dioxide subtraction process is favoured by high pressures (e.g., >3 bar) and low temperatures (preferably <70 °C). The fumes thus purified from a first portion of CO₂ in column 44 and not captured by K₂CO₃ or by amines form the first carbon dioxide flow F1 described above, which feeds the absorption column 18. The liquid potassium carbonate or carbamate solution rich in captured CO₂ is sent through a heat exchanger 46 to a regeneration column 48. The solution rich in captured CO₂ is heated upon passage with the exchanger 46, so that it can have a sufficient temperature to allow the release of CO₂. In fact, in the regeneration column 48, the liquid solution with high temperature and low pressure (atmospheric), is inserted from above into the regeneration column 48 and is crossed in counter-current by a flow of vapour 56 produced by a reboiler 54 with a heat source which further raises it in temperature (over 100 °C) and removes the CO₂ content thereof, which in turn is mixed with the water vapour. The water vapour is produced with the heat source 54 from the regenerated amine or potassium carbonate solution and cooled in the regenerator 48. The mixture of water vapour and carbon dioxide passes a condenser 50 from which condensed water (arrow 52) exits, which feeds the regeneration column 48 and the purified carbon dioxide which forms the above second compressed CO₂ flow F2. The solution with the “absorbent” elements, once the CO₂ is released (which is captured by the vapour), accumulates at the bottom of the column 48, cooling and mixing with the water of the reintroduced condensate (arrow 52). The whole is then sent, as mentioned, to a reboiler with a heat source 54, to evaporate the portion of water which can return to circulation (arrow 56) in the form of vapour to drag new CO₂ into the regeneration column 48, while the heated “absorbent” liquid returns (arrow 58) through the heat exchanger 46, where it is cooled, leaving its heat to the flow entering the regeneration column 48, in the absorption column 44. The heat source 54 can utilize recovery heat from, for example, heat exchanger 14 or from other system recoveries.

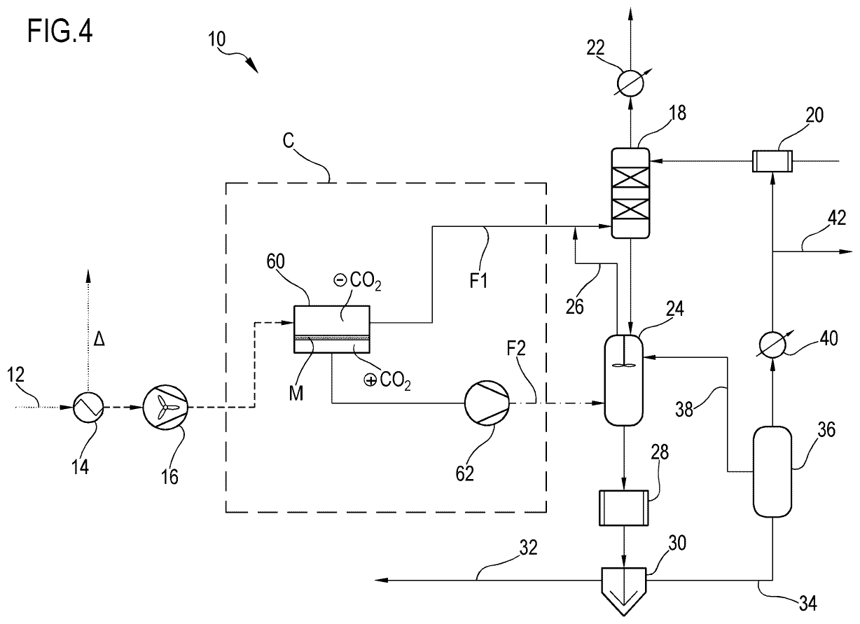

FIG. 4 shows an alternative to the amine capture system or via K₂CO₃. The capture unit C includes a membrane separation system. The fumes cooled by the heat exchanger 14 preferably pass into a blower or a compressor 16 and enter a cross-flow membrane separator 60 wherein the membrane M separates the gas into a portion with reduced CO₂ content (−CO₂) and a fraction with increased CO₂ content (+CO₂). The reduced carbon dioxide fraction is sent as flow F1 to the absorption column 18, while the increased CO₂ fraction passes a compressor 62, or a vacuum pump, to then be sent as flow F2 to the reactor 24.

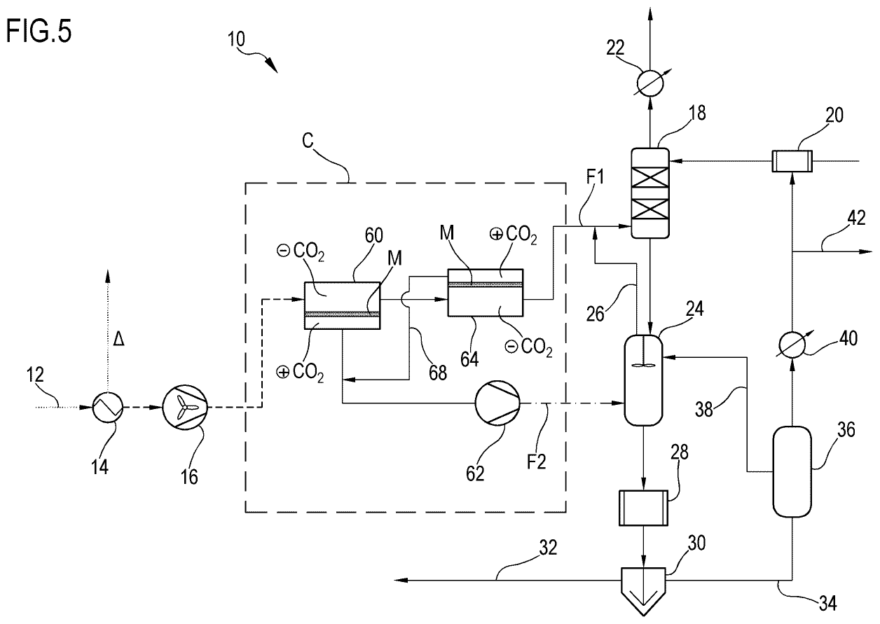

In contrast to FIG. 4, FIG. 5 comprises a two-stage membrane separator system (it is clear that multiple separation stages are also possible to increase recovery efficiency). A further membrane separator 64 is inserted between the membrane separator 60 and the absorption column 18, which is fed by the CO₂-poor fraction exiting the first membrane separator 60. This further membrane separator 64 in turn separates the gas into a portion with reduced CO₂ content (−CO₂) and a fraction with increased CO₂ content (+CO₂). The portion with reduced CO₂ content (−CO₂) feeds the absorption column 18 as flow F1; and the fraction with increased CO₂ content (+CO₂) feeds (through 68) flow F2.

In FIGS. 3 to 5, solid lines mean room temperature flows, dashed lines mean cold flows, dotted lines mean hot flows, and a mixed dashed/dotted line means compressed gas flows. Other CO₂ capture systems known to the person skilled in the art are conceivable for the capture unit.

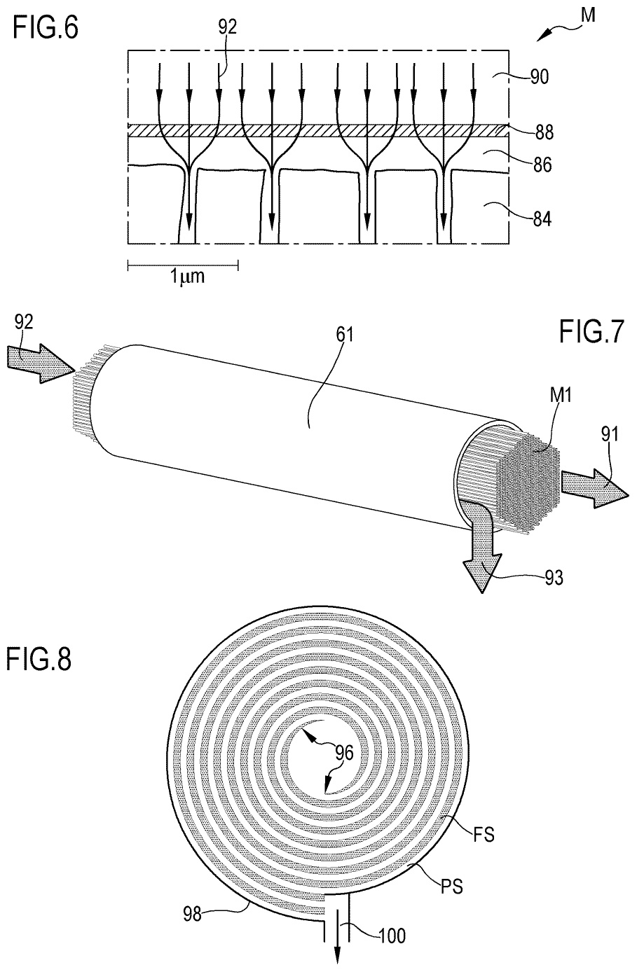

FIG. 6 shows a section of a porous membrane M of a membrane separator. A porous support 84 with an exemplary thickness of 50-100 μm is noted, followed by a channel 86 and subsequently by a selective layer 88 representing the actual separation element (typical thickness 1,000 A). All this is protected by a coating layer 90. Such a composite structured membrane therefore has a very thin selective layer which is bonded to a microporous support layer which provides mechanical strength to support the pressure difference between feed and permeate side.

In another executive example (not depicted), the capture unit C could contain a system which captures and separates CO₂ by adsorption, such as a system working according to the PSA principle. In this regard, the state of the art knows two-reactor systems wherein each reactor comprises an adsorbent material which is permeable for CO₂, while other gases are retained (adsorbed) in the adsorbent material. It starts with feeding the first reactor with the gas mixture under high pressure (5-10 bar), closing the feed of the second reactor. The CO₂ exiting the reactor can be used in the second step of the process according to the invention. As the load of the adsorbent material from the adsorbed gases increases, the pressure in the first reactor drops and the feed of the first reactor is closed to open that of the second reactor which starts the CO₂ separation. At the same time, under reduced pressure, the gases adsorbed in the first reactor detach from the adsorbent material and are discharged from the system. When the pressure in the second reactor drops and reaches a certain value, its feed is interrupted, which will be directed back to the first reactor. The regeneration begins at low pressure in the second reactor. Therefore, there is a continuous exchange between separation by adsorption and regeneration of the adsorbent material between the first and second reactors, caused by the variation of the pressure inside the relative reactor.

FIG. 7 shows a membrane separator comprising a plurality of hollow fibres M1 inside a tube 61 which are crossed by the feed 92 during use. A part of the gas crosses the fibre walls as permeate 93 (i.e., in the present case the fraction rich in carbon dioxide), while the remaining flow exits as retentate 91, i.e., the fraction poor in carbon dioxide.

FIG. 8 shows an alternative for the membrane configuration wherein a plurality of membrane sheets are spirally wound together, creating a space for the feed FS and a space for the permeate PS between the individual sheets. The number 98 indicates an external cover, while the opening 100 indicates the discharge of the permeate. A sweep gas can be introduced in position 96. The feed and retentate flow are perpendicular to the section, while the permeate flows inside the spiral pattern perpendicular to the other flows. In these membrane separators, the single module has an arrangement of crossed flows, but by suitably connecting them in series and always passing the permeate through the previous spiral, it is possible to obtain a counter-current configuration with respect to the feed and the retentate flow.

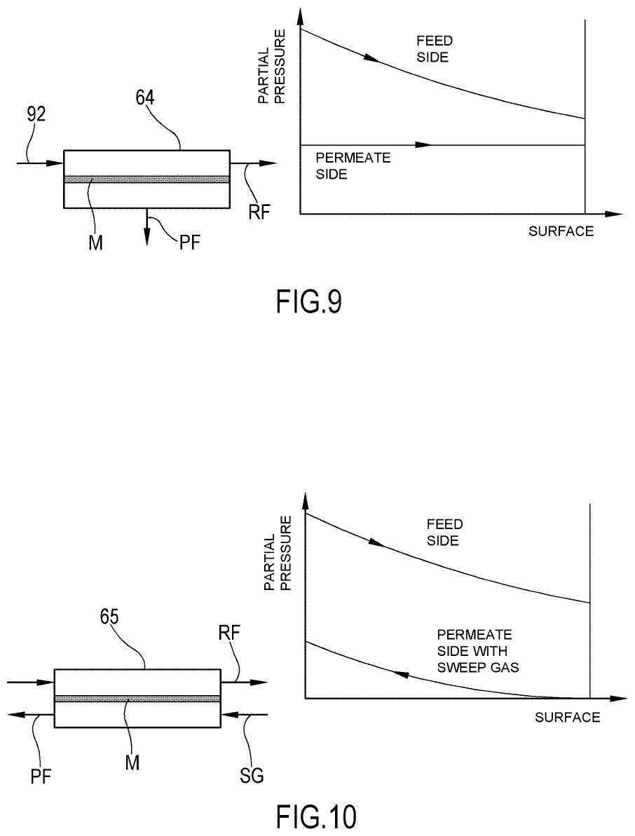

FIG. 9 shows a membrane separator 64 on the left which is schematically divided by a membrane M into two sectors. The feed 92 enters the separator 64. The retentate flow RF exits from one sector (in the same direction as the feed 92), while the permeate flow PF exits from the other sector, perpendicular to the other flows. The graph alongside (right) shows that with respect to the passed surface of the membrane, the partial pressure of the permeate is constant, while the pressure on the feed side is decreasing.

FIG. 10 shows a membrane separator 65 on the left which is schematically divided by a membrane M into two sectors. The feed 92 enters the separator 65. The retentate flow RF exits from one sector (in the same direction as the feed), while the permeate flow PF exits from the other sector in the opposite direction, which with respect to the flow PF in FIG. 9 has changed direction, because in this case, in counter-current with the flow of the feed and the retentate RF, a sweep gas SG is introduced. The graph alongside (figure on the right) shows that with respect to the passed surface of the membrane, the partial pressure of the permeate is increasing towards the beginning of the surface traversed, while it is decreasing on the feed side.

1. A plant for capturing and recovering CO₂ from process fumes comprising:
(a) a furnace producing, during use, heat and fumes containing CO₂;
(b) a CO₂ capture and separation unit downstream of said furnace, with a first outlet and relative first duct and with a second outlet and relative second duct, wherein each outlet and relative duct is fed during use by a gas flow containing a portion of the captured and separated CO₂, said gas flow having a different CO₂ concentration with respect to that fed to the CO₂ capture and separation unit;
(c) a first gas washing device adapted to wash the CO₂ with aqueous MOH, wherein M is an alkali and connected to said first duct for feeding with CO₂;
(d) a reactor adapted to execute a reaction between an alkali metal carbonate and CO₂ connected to said second duct and to said first gas washing device for feeding respectively with CO₂ and the alkali metal carbonate and provided with a discharge for the extraction of the alkali metal bicarbonate produced during use by a reaction between CO₂ and the alkali metal carbonate.

2. The CO₂ capture and recovery plant according to claim 1, wherein the CO₂ capture and recovery plant comprises, downstream of said furnace
(e) a first heat exchanger for recovering the heat of the fumes inside the plant.

3. The CO₂ capture and recovery plant according to claim 1, wherein the CO₂ capture and recovery plant further comprises
(f) a crystallizer which is connected to said discharge;
(g) a filter or a centrifuge for separating the alkali metal bicarbonate produced during use in said reactor;
(h) a concentrator downstream of said filter or centrifuge that is connected to said reactor and to said first gas washing device for feeding the reactor with the concentrate produced during use and for feeding the first gas washing device with any vapours generated within the concentrator, after condensation in a tank that serves as a source of alkali metal hydroxide.

4. The CO₂ capture and recovery plant according to claim 1, wherein said CO₂ capture and separation unit comprises:
(b-1) a second gas washing device adapted to chemically bind or absorb CO₂ with an aqueous solution, preferably containing amines or potassium carbonate;
(b-2) downstream of said second gas washing device, a regeneration device adapted to release the CO₂ absorbed or bound in the second gas washing device;
wherein said second gas washing device comprises said first outlet and is connected by means of said first duct to said first gas washing device; and
wherein said regeneration device comprises said second outlet and is connected by means of said second duct to said reactor.

5. The CO₂ capture and recovery plant according to claim 4, wherein said second gas washing device and said regeneration device are connected through a second heat exchanger to heat the flow of the solution with the captured CO₂ exiting from said second gas washing device and intended for the regeneration device and simultaneously cool the regenerated solution exiting from the regeneration device and heated by a heat source contained in the plant to feed the second gas washing device.

6. The CO₂ capture and recovery plant according to claim 1, wherein said CO₂ capture and separation unit comprises a first membrane separator adapted to separate CO₂ from a gas flow, producing a first gas flow enriched with CO₂ and a second gas flow with reduced CO₂ content, wherein said first membrane separator comprises said first outlet and said second outlet and feeds said first gas washing device with said gas flow with reduced content of CO₂ through said first duct connected to said first outlet, and feeds said reactor with said gas flow enriched with CO₂ through said second duct connected to said second outlet.

7. The CO₂ capture and recovery plant according to claim 6, wherein at least one further membrane separator which is fed by the low CO₂ content fraction exiting from said first membrane separator and which feeds the CO₂-enriched fraction to the second duct and the fraction with reduced CO₂ content to the first gas washing device is inserted between said first membrane separator and said first gas washing device.

8. The CO₂ capture and recovery plant according to claim 1, wherein said CO₂ capture and separation unit comprises an adsorption capture and separation system adapted to separate CO₂ from the fumes.

9. The CO₂ capture and recovery plant according to claim 1, wherein said reactor is a three-phase reactor.

10. The CO₂ capture and recovery plant according to claim 1, wherein said furnace is a reheating furnace.

11. A process for the capture and recovery of CO₂ from process fumes comprising the following steps:
(i) producing heat and fumes containing CO₂ with a furnace;
(ii) capturing and separating said CO₂ in a capture unit;
(iii) dividing the captured and separated CO₂ into a first CO₂ flow and a second CO₂ flow;
(iv) washing said first flow with aqueous MOH with the production of alkali metal carbonate M₂CO₃;
(v) reaction between said alkali metal carbonate and said second CO₂ flow with the formation of alkali metal bicarbonate MHCO₃; and
(vi) separating said alkali metal bicarbonate.

12. The process for the capture and recovery of CO₂ according to claim 11, wherein the capture and separation of CO₂ in step (ii) occurs with at least one of the following options:
(A) with
(ii-a) washing the CO₂ with an aqueous solution, which absorbs or chemically binds the CO₂; and
(ii-b) the subsequent release of the CO₂ absorbed or bound in step (ii-a),
wherein portions of CO₂ unabsorbed or bound in step (ii-a) form the first CO₂ flow and the CO₂ released in step (ii-b) forms the second CO₂ flow;
(B) with a membrane separation which generates a CO₂-enriched flow which forms the second CO₂ flow and in a flow with reduced CO₂ content which forms the first CO₂ flow;
(C) with an adsorption separation.

13. The CO₂ capture and recovery plant according to claim 1, wherein first gas washing device is an absorption column.

14. The CO₂ capture and recovery plant according to claim 1, wherein the alkali metal M is sodium (Na) or potassium (K).

15. The CO₂ capture and recovery plant according to claim 3, wherein said reactor has a gas vent connected to said first duct.

16. The CO₂ capture and recovery plant according to claim 3, wherein said second gas washing device is an absorption column.

17. The CO₂ capture and recovery plant according to claim 5 wherein the plant comprises, downstream of the regeneration device, a compressor to compress the CO₂.

18. The CO₂ capture and recovery plant according to claim 8 wherein the adsorption capture and separation system is a PSA system.

19. The process for the capture and recovery of CO₂ from process fumes according to claim 11 wherein the process uses, at least partially, the heat coming from said furnace and wherein M is Na or K.

20. The process for the capture and recovery of CO₂ from process fumes according to claim 12 wherein the aqueous solution comprises amines or potassium carbonate; wherein the solution freed of CO₂ is heated and then reused in step (ii-a) by heating with the heated solution, prior to its reuse in step (ii-a), the solution containing the CO₂ absorbed or bound between step (ii-a) and step (ii-b) in a heat exchanger (46); and wherein the adsorption separation is performed according to PSA technology.
